(19) United States
(12) Patent Application Publication
(10) Pub. No.: US 2026/0078873 A1
(43) Pub. Date: Mar. 19, 2026

(54) GAS STORAGE SYSTEM CAPABLE OF MAINTAINING STABLE PRESSURE IN PRESSURIZED STORAGE TANK

(71) Applicant: Jincheng LIU, Shijiazhuang (CN)

(72) Inventors: Jincheng LIU, Shijiazhuang (CN); Yanshu GUO, Shijiazhuang (CN)

(73) Assignee: Jincheng LIU, Shijiazhuang (CN)

(21) Appl. No.: 19/400,340

(22) Filed: Nov. 25, 2025

Related U.S. Application Data
(63) Continuation of application No. PCT/CN2024/095543, filed on May 27, 2024.

(30) Foreign Application Priority Data
May 31, 2023 (CN) 202310633134.6

(51) Int. Cl. F17C 1/00

(52) U.S. Cl. CPC F17C 1/00; F17C 2201/0109; F17C 2201/0128; F17C 2203/0604; F17C 2205/0355; F17C 2223/0123; F17C 2227/0316; F17C 2227/0323; F17C 2227/0348; F17C 2227/0355

(57) ABSTRACT

A gas storage system capable of maintaining stable pressure in a pressurized storage tank, includes a pressure-stabilized gas storage tank and a pressure-stabilizing medium charging and discharging system connected to the pressure-stabilized gas storage tank. The pressure-stabilized gas storage tank includes a pressure-bearing shell capable of bearing a pressure of a storage gas, an elastic liner arranged in the pressure-bearing shell, and a support device for the elastic liner. A pressure-stabilizing medium may be a liquid medium, and a volume of the storage tank is adjusted by charging through pressurizing with a pump or by automatic discharging. The pressure-stabilizing medium may also be a low-boiling-point phase-changeable medium under an operating pressure, and evaporation-condensation of the pressure-stabilizing medium is automatically adjusted according to a variation in a volume of a stored gas by using a matched evaporation-condensation system.

### CROSS-REFERENCE TO RELATED APPLICATIONS

This application is a continuation of International Patent Application No. PCT/CN2024/095543 with a filing date of May 27, 2024, designating the United States, now pending, and further claims priority to Chinese Patent Application No. 202310633134.6 with a filing date of May 31, 2023. The content of the aforementioned applications, including any intervening amendments thereto, is incorporated herein by reference.

### FIELD OF TECHNOLOGY

The present disclosure relates to the technical field of pressurized gas storage, and particularly to a gas storage system capable of maintaining stable pressure in a pressurized storage tank.

### BACKGROUND

In existing pressurized gas storage tanks, the pressure varies over a wide range as the medium inside the tank is charged, used, and discharged. This not only affects the stability of upstream and downstream users, but also increases the difficulty of charging and also the difficulty of configuration and operation for downstream users'compressors/boosters. Therefore, there is an urgent need to develop a gas storage system capable of maintaining stable pressure in a pressurized storage tank.

### SUMMARY

The technical problem to be solved by the present disclosure is to provide a gas storage system capable of maintaining stable pressure in a pressurized storage tank. A volume of a liner is changed by automatic charging and discharging of a pressure-stabilizing medium according to process requirements, thereby changing a volume of a stored medium and keeping a pressure of the storage tank constant.

To solve the above technical problem, the present disclosure adopts the following technical solution:

A gas storage system capable of maintaining stable pressure in a pressurized storage tank includes a pressure-stabilized gas storage tank and a pressure-stabilizing medium charging and discharging system connected to the pressure-stabilized gas storage tank. The pressure-stabilized gas storage tank includes a pressure-bearing shell capable of bearing a pressure of stored gas, an elastic liner arranged in the pressure-bearing shell, and a support device for the elastic liner. When the pressure-stabilizing medium is a liquid medium, the pressure-stabilizing medium charging and discharging system adjusts a volume of the pressure-stabilized gas storage tank by charging through pressurizing with a pump or by automatic discharging. When the pressure-stabilizing medium is a low-boiling-point phase-changeable medium under an operating pressure of the pressure-stabilized gas storage tank, the pressure-stabilizing medium charging and discharging system automatically adjusts evaporation-condensation of the pressure-stabilizing medium according to a variation in a volume of the stored gas by using a matched evaporation-condensation system, so that part of the volume of the pressure-stabilized gas storage tank is filled or evacuated.

As a further improvement of the technical solution of the present disclosure, when the pressure-stabilizing medium is the liquid medium, the pressure-stabilizing medium charging and discharging system specifically includes a pressurizing pump, a low-pressure liquid storage tank, an energy recovery unit, a generator, and connecting tubes. The generator is connected to the energy recovery unit. A pressure-stabilizing medium inlet of the energy recovery unit is in communication with an inlet and outlet port of a pressure-stabilizing medium storage space in the pressure-stabilized gas storage tank through a liquid discharge valve. A pressure-stabilizing medium outlet of the energy recovery unit is connected to an inlet of the low-pressure liquid storage tank. An outlet of the low-pressure liquid storage tank is connected to the pressurizing pump. The pressurizing pump is connected to the inlet and outlet port of the pressure-stabilizing medium storage space in the pressure-stabilized gas storage tank through a liquid charge valve. A pressure-differential pressure transmitter interlocked with the liquid discharge valve and the liquid charge valve is arranged between the elastic liner and the pressure-bearing shell. A position switch interlocked with the liquid charge valve is arranged outside the elastic liner.

As a further improvement of the technical solution of the present disclosure, the pressure-stabilized gas storage tank is cylindrical or spherical in shape.

As a further improvement of the technical solution of the present disclosure, a stored gas space in the pressure-stabilized gas storage tank is in the elastic liner or between the elastic liner and the pressure-bearing shell. When the stored gas space is in the elastic liner, the pressure-stabilizing medium storage space is between the elastic liner and the pressure-bearing shell. When the stored gas space is between the elastic liner and the pressure-bearing shell, the pressure-stabilizing medium storage space is in the elastic liner.

As a further improvement of the technical solution of the present disclosure, the liquid medium is any one of water, antifreeze, or hydraulic oil.

As a further improvement of the technical solution of the present disclosure, when the pressure-stabilizing medium is the low-boiling-point phase-changeable medium under the operating pressure of the pressure-stabilized gas storage tank, the pressure-stabilizing medium charging and discharging system specifically includes a heating medium circulation pump, a cooling medium circulation pump, a heating medium storage tank, a condenser, an evaporator, a cooling medium storage tank, a detection device arranged in the pressure-stabilized gas storage tank, and connecting tubes. A pressure-stabilizing medium inlet of the condenser is connected to an inlet and outlet port of a pressure-stabilizing medium storage space of the pressure-stabilized gas storage tank. A pressure-stabilizing medium outlet of the condenser is connected to a pressure-stabilizing medium inlet of the evaporator. A cooling medium inlet of the condenser is connected to an outlet of the cooling medium circulation pump. A cooling medium outlet of the condenser is connected to an inlet of the heating medium storage tank. An outlet of the heating medium storage tank is connected to an inlet of the heating medium circulation pump. An outlet of the heating medium circulation pump is connected to a heating medium inlet of the evaporator. A heating medium outlet of the evaporator is connected to an inlet of the cooling medium storage tank. An outlet of the cooling medium storage tank is connected to an inlet of the cooling medium circulation pump. A pressure-stabilizing medium outlet of the evaporator is connected to the inlet and outlet port of the pressure-stabilizing medium storage space of the pressure-stabilized gas storage tank.

As a further improvement of the technical solution of the present disclosure, the heating medium and the cooling medium are a same medium. The heating medium storage tank, the cooling medium storage tank, and a tube connected thereto are all provided with thermal insulation structures.

As a further improvement of the technical solution of the present disclosure, the low-boiling-point phase-changeable medium is selected according to the operating pressure of the pressure-stabilized gas storage tank. When the operating pressure is 3.0 MPa, butane is used. When the operating pressure is 2.0 MPa, ammonia is used.

As a further improvement of the technical solution of the present disclosure, an inlet and an outlet for a stored medium of the pressure-stabilized gas storage tank are combined into one inlet and outlet port. The pressure-stabilized gas storage tank is also capable of storing a liquid.

By adopting the above technical solutions, the technical advancements achieved by the present disclosure are as follows:
1. In the present disclosure, by providing the pressure-stabilized gas storage tank including the pressure-bearing shell capable of bearing the pressure of the stored gas and the elastic liner arranged in the pressure-bearing shell, and the pressure-stabilizing medium charging and discharging system connected to the pressure-stabilizing medium storage space of the pressure-stabilized gas storage tank, the volume of the liner is changed by automatic charging and discharging of the pressure-stabilizing medium according to process requirements, thereby changing the volume of the stored medium and keeping the pressure of the pressure-stabilized gas storage tank constant.
2. In the present disclosure, when the pressure-stabilizing medium is water, antifreeze, hydraulic oil, or another liquid medium, the volume of the pressure-stabilized gas storage tank is adjusted by charging through pressurizing with the pressurizing pump or by automatic discharging. Moreover, energy released when discharging the liquid pressure-stabilizing medium is recovered by the energy recovery unit, which drives the generator to generate electricity, thus supplying power to the pressure-stabilizing medium charging and discharging system and saving energy while keeping the pressure of the pressure-stabilized gas storage tank constant.
3. In the present disclosure, when the pressure-stabilizing medium is the low-boiling-point phase-changeable medium under the operating pressure, evaporation-condensation of the pressure-stabilizing medium is automatically adjusted according to the variation in the volume of the stored gas by using the matched evaporation-condensation system, so that part of the volume of the pressure-stabilized gas storage tank is filled or evacuated, thereby achieving the effect of stabilizing the pressure of the stored medium.
4. In the present disclosure, by using the pressure-stabilized gas storage tank and the pressure-stabilizing medium charging and discharging system, the pressure of the pressure-stabilized gas storage tank is maintained stable during charging and discharging of the storage gas, thereby ensuring the stability of the upstream and downstream users and reducing the difficulty of configuration and operation for downstream users'compressors/boosters.

### BRIEF DESCRIPTION OF THE DRAWINGS

In order to more clearly illustrate the technical solutions of the embodiments or the prior art of the present disclosure, the following is a brief introduction to the accompanying drawings required in the description of the embodiments or the prior art. It is apparent that the accompanying drawings described below are some embodiments of the present disclosure. For those skilled in the art, other drawings can also be obtained based on these accompanying drawings without creative effort.

FIG. 1 is a schematic diagram of a gas storage system capable of maintaining stable pressure in a pressurized storage tank according to Embodiment 1 of the present disclosure;

FIG. 2 is a schematic diagram of the gas storage system capable of maintaining stable pressure in a pressurized storage tank according to Embodiment 2 of the present disclosure; and

FIG. 3 is a schematic diagram of the gas storage system capable of maintaining stable pressure in a pressurized storage tank according to Embodiment 3 of the present disclosure.

In the figures: 1: heating medium circulation pump; 2: cooling medium circulation pump; 3: heating medium storage tank; 4: condenser; 5: evaporator; 6: pressure-stabilized gas storage tank; 61: pressure-bearing shell; 62: elastic liner; 7: cooling medium storage tank; 8: pressurizing pump; 9: low-pressure liquid storage tank; 10: generator; 11: liquid discharge valve; 12: pressure-differential pressure transmitter; 13: position switch; 14: liquid charge valve; 15: energy recovery unit; 16: condensing/evaporating device; 17: pressure-stabilizing medium storage tank; 18: pressure-stabilizing medium circulation pump.

### DESCRIPTION OF THE EMBODIMENTS

It should be noted that the terms “include” and “have” and any variations thereof in the specification, claims, and accompanying drawings of the present disclosure are intended to cover non-exclusive inclusion. For example, a process, method, system, product, or apparatus that includes a series of steps or elements does not necessarily include only those steps or elements explicitly listed, but may also include other steps or elements not explicitly listed or inherent to such process, method, product, or apparatus.

The present disclosure will be further described in detail below in conjunction with the accompanying drawings and embodiments:

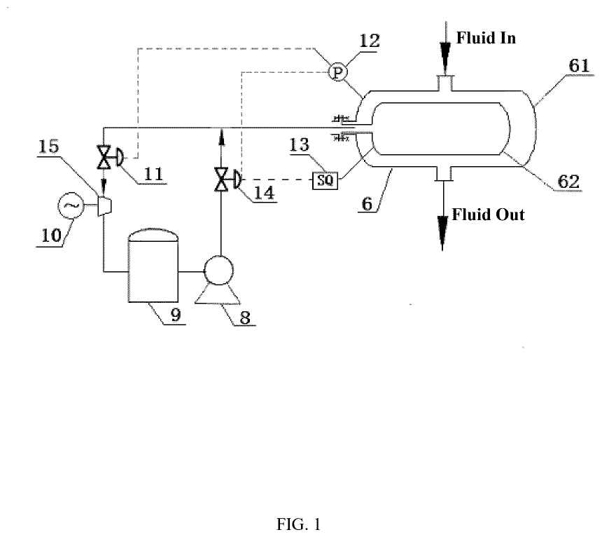

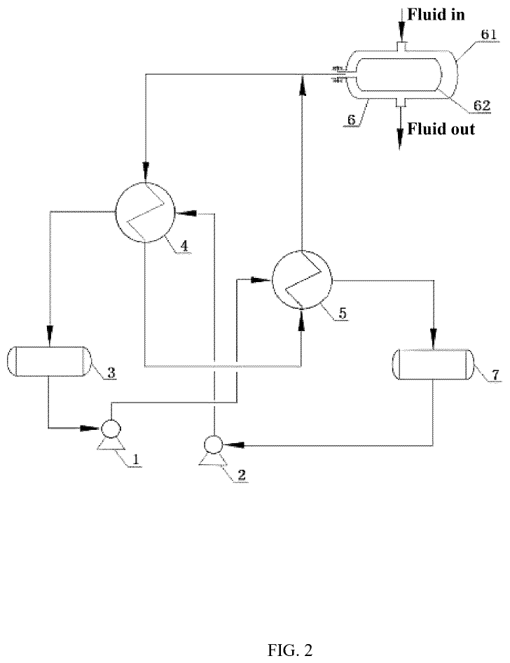

As shown in FIG. 1 to FIG. 2, a gas storage system capable of maintaining stable pressure in a pressurized storage tank includes a pressure-stabilized gas storage tank 6 and a pressure-stabilizing medium charging and discharging system connected to the pressure-stabilized gas storage tank 6. The pressure-stabilized gas storage tank 6 includes a pressure-bearing shell 61 capable of bearing a pressure of a stored gas, an elastic liner 62 arranged in the pressure-bearing shell 61, and a support device for the elastic liner 62. A volume of the elastic liner 62 is changed by automatic charging and discharging of the pressure-stabilizing medium according to process requirements, thereby changing the volume of the stored gas and keeping a pressure of the pressure-stabilized gas storage tank 6 constant. The support device may be omitted when the volume of the pressure-stabilized gas storage tank 6 is small.

Further, the pressure-stabilized gas storage tank 6 may be of various shapes, such as cylindrical or spherical.

Further, a stored gas space in the pressure-stabilized gas storage tank 6 may be in the elastic liner 62 or between the elastic liner 62 and the pressure-bearing shell 61. When the stored gas space is in the elastic liner 62, the pressure-stabilizing medium storage space is between the elastic liner 62 and the pressure-bearing shell 61. When the stored gas space is between the elastic liner 62 and the pressure-bearing shell 61, the pressure-stabilizing medium storage space is in the elastic liner 62.

Further, the pressure-stabilizing medium may be water, antifreeze, hydraulic oil, or a different liquid medium. The volume of the pressure-stabilized gas storage tank 6 is adjusted by charging through pressurizing with a pressurizing pump 8 or by automatic discharging. Alternatively, the pressure-stabilizing medium may be a low-boiling-point phase-changeable medium under an operating pressure of the pressure-stabilized gas storage tank 6, and evaporation-condensation of the pressure-stabilizing medium is automatically adjusted according to the variation in the volume of the stored gas in the pressure-stabilized gas storage tank 6 by using a matched evaporation-condensation system, so that part of the volume of the pressure-stabilized gas storage tank 6 is filled or evacuated, thereby achieving the effect of stabilizing the pressure of the stored gas.

Further, an inlet and an outlet for the stored medium of the pressure-stabilized gas storage tank 6 may be provided separately (as shown by “Fluid In” and “Fluid Out” in FIG. 1 to FIG. 3), or may be combined into one inlet and outlet port for the stored medium.

The pressure-stabilized gas storage tank 6 may also store a liquid, not limited to a gas.

### Embodiment 1

As shown in FIG. 1, when the stored gas space of the pressure-stabilized gas storage tank 6 is between the elastic liner 62 and the pressure-bearing shell 61, the pressure-stabilizing medium storage space is in the elastic liner 62. When the pressure-stabilizing medium is a liquid, the pressure-stabilizing medium charging and discharging system includes a pressurizing pump 8, a low-pressure liquid storage tank 9, an energy recovery unit 15, a generator 10, and connecting tubes. The generator 10 (or another energy-consuming apparatus) is connected to the energy recovery unit 15. A pressure-stabilizing medium recovery port of the energy recovery unit 15 is connected to an inlet and outlet port of a pressure-stabilizing medium storage space in the pressure-stabilized gas storage tank 6 through a liquid discharge valve 11. A pressure-stabilizing medium outlet of the energy recovery unit 15 is connected to an inlet of the low-pressure liquid storage tank 9. An outlet of the low-pressure liquid storage tank 9 is connected to the pressurizing pump 8. The pressurizing pump 10 is connected to the inlet and outlet port of the pressure-stabilizing medium storage space in the pressure-stabilized gas storage tank 6 through a liquid charge valve 14. A pressure-differential pressure transmitter 12 interlocked with the liquid discharge valve 11 and the liquid charge valve 14 is arranged between the elastic liner 62 and the pressure-bearing shell 61 of the pressure-stabilized gas storage tank 6. A position switch 13 interlocked with the liquid charge valve 14 is arranged outside the elastic liner 62 of the pressure-stabilized gas storage tank 6.

The specific operation process is as follows:

When the pressure-stabilized gas storage tank 6 is not fully filled and the stored gas is being charged into the pressure-stabilized gas storage tank, the pressure-stabilizing medium space in the elastic liner 62 is squeezed, causing the pressure inside the pressure-stabilized gas storage tank 6 to rise. The pressure-differential pressure transmitter 12 triggers the liquid discharge valve 11 to open, and adjusts an opening of the liquid discharge valve 11 according to a charging rate to maintain stable pressure in the pressure-stabilized gas storage tank 6. The energy recovery unit 15 recovers energy released by the pressure-stabilizing medium, which is supplied to the generator 10 to generate electricity (or to drive another energy-consuming apparatus). The electricity generated by the generator 10 can be used to power the pressure-stabilized medium charging and discharging system (or another energy-consuming apparatus).

When the stored medium is being discharged from the pressure-stabilized gas storage tank 6, the pressure inside the pressure-stabilized gas storage tank 6 decreases. The pressurizing pump 8 is activated to charge the pressure-stabilizing medium (liquid) into the pressure-stabilized gas storage tank 6. The pressure-differential pressure transmitter 12 triggers the liquid charge valve 14 to open, and a charging rate of the pressure-stabilizing medium is adjusted by adjusting an opening of the liquid charge valve 14 to maintain stable pressure inside the pressure-stabilized gas storage tank 6. Moreover, the position switch 13 arranged on the elastic liner 62 is interlocked with the liquid charge valve 14. When the elastic liner 62 reaches its maximum displacement during charging, the liquid charge valve 14 closes to complete the charging of the pressure-stabilizing medium (liquid), thereby preventing damage to the elastic liner 62 and effectively prolonging the service life of the pressure-stabilized gas storage tank 6.

### Embodiment 2

As shown in FIG. 2, when the stored gas space of the pressure-stabilized gas storage tank 6 is between the elastic liner 62 and the pressure-bearing shell 61, the pressure-stabilizing medium storage space is in the elastic liner 62. When the pressure-stabilizing medium is a low-boiling-point phase-changeable medium under the operating pressure of the pressure-stabilized gas storage tank 6, the pressure-stabilizing medium charging and discharging system includes a heating medium circulation pump 1, a cooling medium circulation pump 2, a heating medium storage tank 3, a condenser 4, an evaporator 5, a cooling medium storage tank 7, a detection device arranged in the pressure-stabilized gas storage tank 6, and connecting tubes. A pressure-stabilizing medium inlet of the condenser 4 is connected to an inlet and outlet port of the pressure-stabilizing medium storage space of the pressure-stabilized gas storage tank 6. A pressure-stabilizing medium outlet of the condenser 4 is connected to a pressure-stabilizing medium inlet of the evaporator 5. A cooling medium inlet of the condenser 4 is connected to an outlet of the cooling medium circulation pump 2. A cooling medium outlet of the condenser 4 is connected to an inlet of the heating medium storage tank 3. An outlet of the heating medium storage tank 3 is connected to an inlet of the heating medium circulation pump 1. An outlet of the heating medium circulation pump 1 is connected to a heating medium inlet of the evaporator 5. A heating medium outlet of the evaporator 5 is connected to an inlet of the cooling medium storage tank 7. An outlet of the cooling medium storage tank 7 is connected to an inlet of the cooling medium circulation pump 2. A pressure-stabilizing medium outlet of the evaporator 5 is connected to the inlet and outlet port of the pressure-stabilizing medium storage space of the pressure-stabilized gas storage tank 6.

The specific operation process is as follows:

When the stored gas is being charged, the pressure inside the pressure-stabilized gas storage tank 6 rises. When the detection device detects the rise of the pressure, the cooling medium circulation pump 2 is activated to condense the pressure-stabilizing medium in the condenser 4, thereby reducing the volume occupied by the gaseous pressure-stabilizing medium and achieving a pressure-stabilizing effect. A circulation rate of the cooling medium is automatically adjusted according to the pressure inside the pressure-stabilized gas storage tank 6.

When the stored gas is being discharged, the pressure inside the pressure-stabilized gas storage tank 6 decreases. When the detection device detects the decrease of the pressure, the heating medium circulation pump 1 is activated to evaporate part of the liquid pressure-stabilizing medium, thereby filling the volume vacated in the pressure-stabilized gas storage tank 6 due to discharge and maintaining stable pressure inside the pressure-stabilized gas storage tank 6. Similarly, a circulation rate of the heating medium is automatically adjusted according to the discharging rate of the stored medium in the tank, thereby ensuring that the evaporation rate of the pressure-stabilizing medium matches the discharging rate of the stored gas. When the pressure-stabilized gas storage tank 6 is fully filled with the stored gas, the detection device automatically stops charging to prevent damage to the elastic liner 62.

The heating medium and the cooling medium are a same medium, and apparatuses and tubes thereof are well insulated to minimize dependence on external heat sources and cooling media, thereby maximizing the use of the condensation latent heat of the pressure-stabilizing medium as the external heat supply during evaporation. The pressure-stabilizing medium may be selected according to the operating pressure of the pressure-stabilized gas storage tank 6. For example, when the operating pressure is around 3.0 MPa, butane may be used. When the operating pressure is around 2.0 MPa, ammonia may be used. The above examples are for illustration only and are not limited to the options mentioned. In actual operation, other options may also be used.

### Embodiment 3

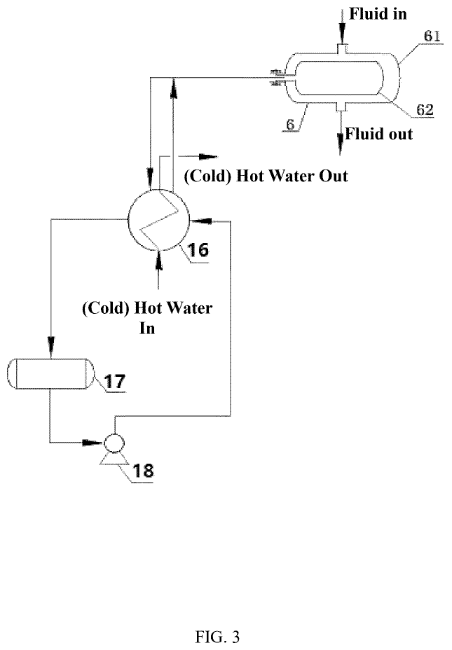

As shown in FIG. 3, when the stored gas space of the pressure-stabilized gas storage tank 6 is between the elastic liner 62 and the pressure-bearing shell 61, the pressure-stabilizing medium storage space is in the elastic liner 62. When the pressure-stabilizing medium is a low-boiling-point phase-changeable medium under the operating pressure of the pressure-stabilized gas storage tank 6, the pressure-stabilizing medium charging and discharging system includes a condensing/evaporating device 16 (which combines the condenser 4 and the evaporator 5 into one device), a pressure-stabilizing medium storage tank 17, a pressure-stabilizing medium circulation pump 18, a detection device arranged in the pressure-stabilized gas storage tank 6, connecting tubes, and the like. The condensing/evaporating device 16 is provided with a (cold) hot water inlet and a (cold) hot water outlet to condense the pressure-stabilizing medium by cooling and evaporate the pressure-stabilizing medium by heating. Valves are arranged at appropriate positions on the tubes. The condensing/evaporating device 16 may automatically condense or evaporate the pressure-stabilizing medium as needed to balance the pressure inside the pressure-stabilized gas storage tank 6. The specific operation process is similar to that of Embodiment 2 and will not be described in detail here.

It should be noted that the above embodiments are provided only to illustrate the technical solutions of the present disclosure and not to limit them. Although the present disclosure has been described in detail with reference to the foregoing embodiments, those skilled in the art should understand that modifications may be made to the technical solutions described in the foregoing embodiments, or some or all of the technical features may be replaced with equivalents. These modifications or replacements do not make the essence of the corresponding technical solutions deviate from the scope of the technical solutions of the embodiments of the present disclosure.

What is claimed is:

1. A gas storage system capable of maintaining stable pressure in a pressurized storage tank, comprising a pressure-stabilized gas storage tank and a pressure-stabilizing medium charging and discharging system in communication with the pressure-stabilized gas storage tank; wherein the pressure-stabilized gas storage tank comprises a pressure-bearing shell capable of bearing a pressure of stored gas, an elastic liner arranged in the pressure-bearing shell, and a support device for the elastic liner; a volume of the elastic liner is changeable with charging and discharging of the pressure-stabilizing medium, thereby changing a volume of the stored gas to keep the pressure of the storage tank constant; a stored gas space in the pressure-stabilized gas storage tank is in the elastic liner or between the elastic liner and the pressure-bearing shell;
when the pressure-stabilizing medium is a liquid medium, the liquid medium is any one of water, antifreeze, or hydraulic oil; the pressure-stabilizing medium charging and discharging system adjusts a volume of the pressure-stabilized gas storage tank by charging through pressurizing with a pump or by automatic discharging; the pressure-stabilizing medium charging and discharging system specifically comprises a pressurizing pump, a low-pressure liquid storage tank, an energy recovery unit, a generator, and connecting tubes; the generator is connected to the energy recovery unit; a pressure-stabilizing medium inlet of the energy recovery unit is in communication with an inlet and outlet port of a pressure-stabilizing medium storage space in the pressure-stabilized gas storage tank through a liquid discharge valve, a pressure-stabilizing medium outlet of the energy recovery unit is connected to an inlet of the low-pressure liquid storage tank, an outlet of the low-pressure liquid storage tank is connected to the pressurizing pump, and the pressurizing pump is connected to the inlet and outlet port of the pressure-stabilizing medium storage space in the pressure-stabilized gas storage tank through a liquid charge valve; a pressure-differential pressure transmitter interlocked with the liquid discharge valve and the liquid charge valve is arranged between the elastic liner and the pressure-bearing shell; and a position switch interlocked with the liquid charge valve is arranged outside the elastic liner.

2. The gas storage system according to claim 1, wherein the pressure-stabilized gas storage tank is cylindrical or spherical in shape.

3. The gas storage system according to claim 1, wherein when the stored gas space is in the elastic liner, the pressure-stabilizing medium storage space is between the elastic liner and the pressure-bearing shell; and when the stored gas space is between the elastic liner and the pressure-bearing shell, the pressure-stabilizing medium storage space is in the elastic liner.

4. The gas storage system according to claim 1, wherein an inlet and an outlet for a stored medium of the pressure-stabilized gas storage tank are combined into one inlet and outlet port; and the pressure-stabilized gas storage tank is further capable of storing a liquid.
